(19) United States
(12) Patent Application Publication
(10) Pub. No.: US 2020/0217129 A1
(43) Pub. Date: Jul. 9, 2020

(54) Decorative skylight

(71) Applicant: Melvin Hector, Tucson, AZ (US)

(72) Inventor: Melvin Hector, Tucson, AZ (US)

(21) Appl. No.: 16/350,765

(22) Filed: Jan. 3, 2019

(51) Int. Cl. E06B 9/40; E04D 13/03

(52) U.S. Cl. CPC E06B 9/40; E06B 2009/405; E04D 13/033

(57) ABSTRACT

A skylight assembly in which the skylight, passing sunlight from a building's exterior to an interior of a building, has a translucent flexible membrane selectively extending across the skylight and having at least one graphical image imprinted on the flexible membrane.

### BACKGROUND OF THE INVENTION

This invention relates generally to construction and more particularly to skylights found within buildings.

Skylights have the ability to brighten a dark corner or to accent a walkway or room. They provide for exterior light to find its way into the room to provide lighting without the need for electrically generated light.

Those of ordinary skill in the art readily recognize a variety of designs for skylights, including, but not limited to those described in: U.S. Pat. No. 5,130,915, issued on Jul. 14, 1992, to Lerch and entitled “Dome Shaped Lighting Fixture”; U.S. Pat. No. 6,263,624, issued Jul. 24, 2001, to Hoy et al, entitled “Skylight Assembly”; and, U.S. Pat. No. 7,624,547, issued Dec. 1, 2009, to Brinton et al, entitled “Accessory Kit for Fixed Curb-Mounted Skylight”; all of which are issued hereinto by reference.

While the skylights provide light, there is often a need to moderate or eliminate totally the light being pass through. This shading of the skylight has been attempted in several rudimentary a attempts, such as those described in: U.S. Pat. No. 5,568,832, issued Oct. 29, 1996, to Eddy entitled “Skylight Shade”; U.S. Pat. No. 6,338,337, issued Jan. 15, 2002, to Domel entitled “Skylight Assembly with Head Rail-Mounted Actuator”; U.S. Pat. No. 5,088,543, issued Feb. 18, 1992, to Bilbrey entitled “Skylight Shade”; all of which are incorporated hereinto by reference.

While these shading systems do provide a shading of the skylight, they are difficult to use, unattractive, and cumbersome.

It is clear from the forgoing that there is a desire for an enhanced skylight.

### SUMMARY OF THE INVENTION

In this invention, the skylight assembly uses a tubular member. The tubular member extends from an interior of the building to an exterior portion. Typically, this tube has a square or rectangular cross section but other configurations are also contemplated.

A top of the tub ideally extends through the roof, a bottom of the tubular opens onto the interior of the building. In an alternative embodiment, the tubular extends horizontally through a wall of the building. The exterior portion of the tubular is ideally sealed to the elements using a glass or plastic covering.

The invention uses a flexible membrane which is configured to selectively extend across the tube, ideally from one side to an opposing side of the tubular for a square or horizontal cross-sectional tubular. The flexible membrane is translucent in the preferred embodiment and has a graphical image imprinted thereon.

The graphical image is any artist or photographical rendering which the user finds enjoyable, such as but not limited to: birds, clouds, city skylines, forests, etc. In some embodiments, a totally obscure section provides for selectively “blacken” the skylight so that the room is more conducive to sleeping.

When the flexible membrane is not in use, extending across the tube member, the flexible membrane is secured around a first roller positioned within the tube. Movement of the flexible membrane from the roller is accomplished ideally manually using a rod to grasp the flexible membrane and pull it to some anchor brackets on the opposing side of the tube.

In another embodiment, a motor is adapted to pull the flexible membrane from the roller across the tube. Ideally this motor is remote controlled but may also be hardwired to a manual switch accessible to the user.

In this preferred embodiment, a spring mechanism provides a pulling force adapted to encourage the flexible membrane to wrap around the roller; while the motor, positioned on an opposing side of the tubular member, works to pull the flexible membrane from the first roller and onto a second roller.

In the embodiment where two rollers are used, each is motorized allowing the flexible membrane to be pulled either way. This embodiment is useful where there are multiple graphics on the flexible membrane, thereby allowing the user to select the graphic they desire.

Motorized rollers are well known to those of ordinary skill in the art and include, but are not limited to those described in: U.S. Pat. No. 4,722,325, issued Feb. 2, 1988, to Fulkerson entitled “Solar Shutter Arrangement”; and U.S. Pat. No. 4,557,310, issued Dec. 10, 1985, to Castellaw et al entitled “Moveable Sun Shade System”; both of which are incorporated hereinto by reference.

When two motorized rollers are used, a brake mechanism allows both motors to be secured so that the rollers do not permit the flexible membrane to “sag”. Further, a control mechanism is utilized to prevent both motors from being used simultaneously and damage the flexible membrane.

Note, where two motorized motors are used, they are designed to pull/rotate in opposing directions permitting the images or graphics to be selected by the user.

In one embodiment of the invention, the flexible membrane also spools via two free rolling rollers between the first and second motorize roller. This arrangement permits many different images to be used as the motorized rollers without any significant “gaps” on the sides of the tube.

The invention, together with various embodiments thereof, will be fully illustrated by the accompanying drawings and the following descriptions thereof.

### DRAWINGS IN BRIEF

FIG. 1 provides an illustration of a graphic for the present invention.

FIG. 2 illustrates the movement of the covering.

FIGS. 3, 4, and 5 illustrate the mechanical components of the preferred embodiment.

FIG. 6 pictorially depicts the operation of the preferred embodiment of the invention.

FIG. 7 illustrates a flexible membrane having more than one graphical image.

FIG. 8 graphically illustrates an alternative embodiment of the invention.

### DRAWINGS IN DETAIL

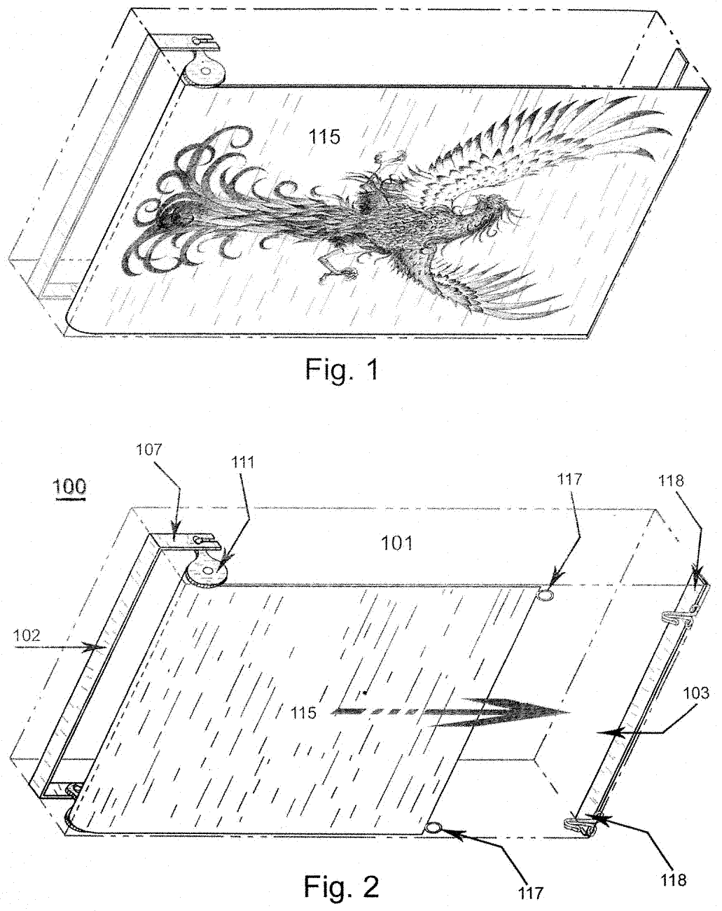

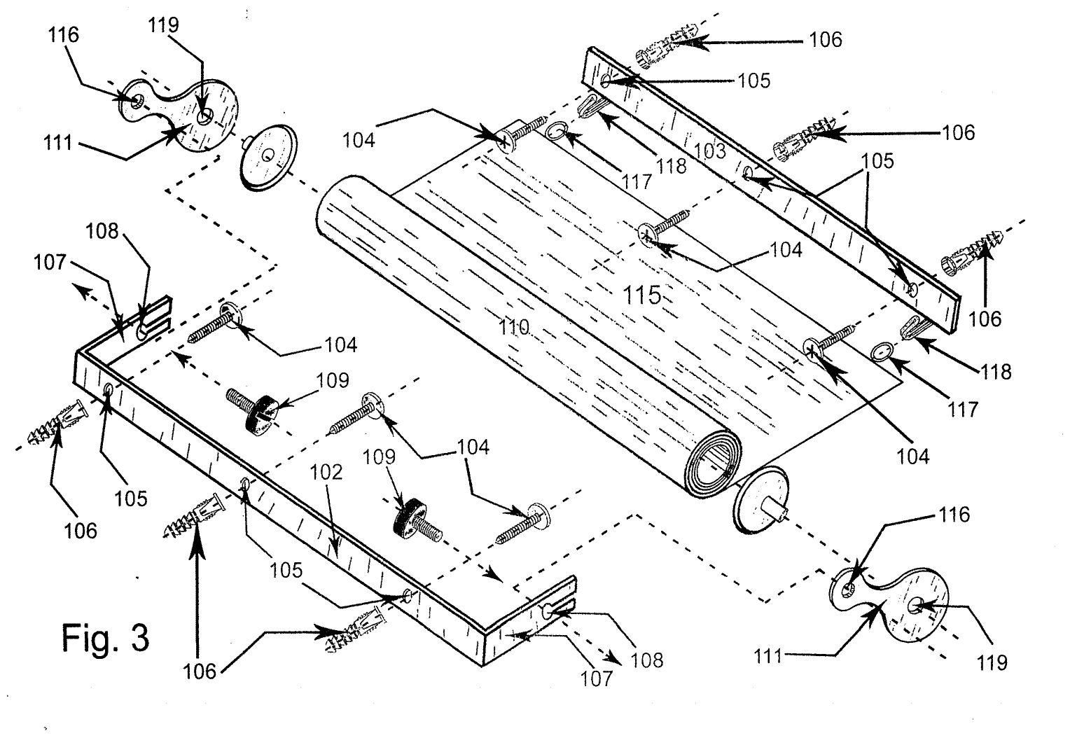

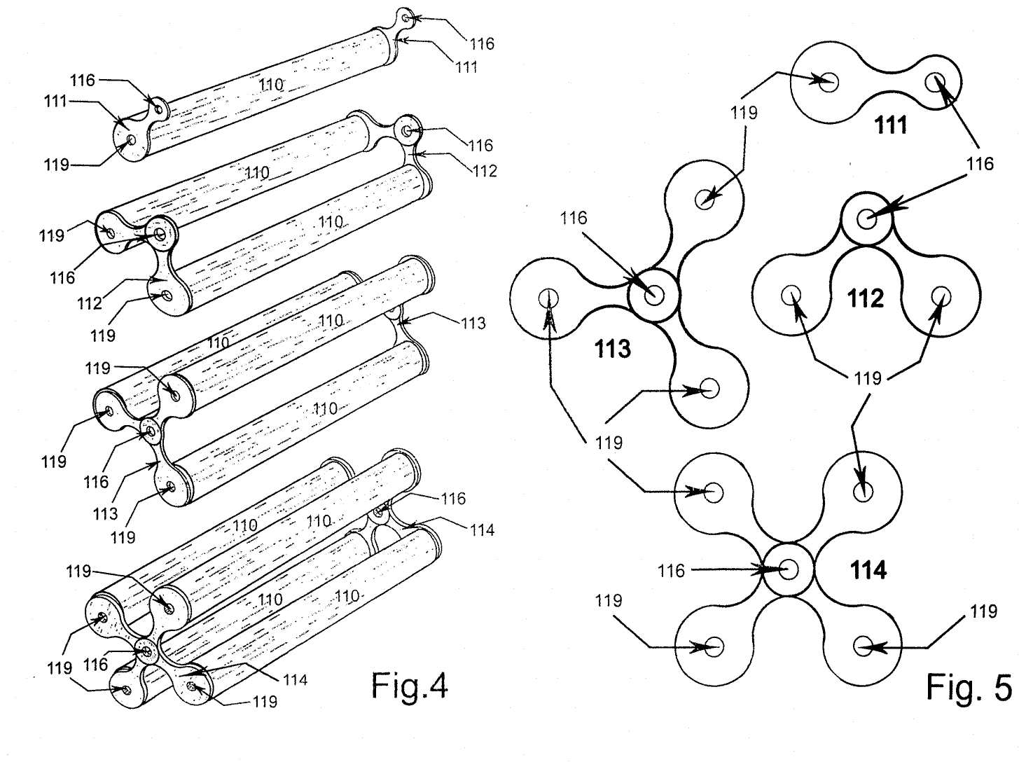

Referring to FIGS. 1-5, the system is a passthrough cover for a skylight assembly 100. It is intended to take up the space outlined by a ceiling skylight opening 101, providing a sunlit background display of a topic of the viewer's choice. Additionally the flexible member provides insulation from heat during the summer from entering through the skylight, or heat during the winter escaping through the skylight, as it forms a closely-fitted, more or less translucent physical barrier across the tube outlined by the skylight.

The passthrough cover for a skylight assembly 100 is formed of a base bracket 102 placed at one end of the length of the chosen skylight opening 101. Across from the base bracket 102, on the other end of the length of the skylight opening 101, is placed an end bracket 103. These two brackets are mounted into the wall substance of the respective ends of the skylight opening 101 by screws 104 that are placed through preset holes 105 in the brackets 102 and 103 into anchors 106 that are placed into several holes drilled into the wall substance of each end of skylight opening 101.

The base bracket 102 has a flange on each end 107 fitted with a base bracket locking notch 108 that accommodates thumb screws 109 for holding variously assorted rollup spring tensioned canisters 110. The tension spring cannisters/rollers have paired mounting end pieces for a one spring tensioned canister display 111.

In some embodiments, paired mounting end pieces are used for a two spring tensioned canister display 112. Paired mounting end pieces, for a three spring tensioned canister display 113, is also used in some embodiments. Other embodiments use or paired mounting end pieces for a four-spring tensioned cannister display 114, or paired mounting end pieces for more than four (not shown) spring tension canisters, that can be alternated to permit the display of the cannister display sheet 115 on the particular individual spring tensioned cannister 110 that the viewer desires.

The paired mounting pieces 111-114 are secured to the base bracket locking notch 108 by thumb screws 109 that transverse the base bracket locking notch 108 and screw into opening 116 on the respective mounting pieces 111-114. When the chosen canister display sheet is so positioned, the paired end mounting pieces 111-114 are selectively tightened into place by the two thumb screws 109 into the opening 116 on the paired mounting pieces 111-114. The designated canister display sheet 115, selected by the viewer is positioned by drawing the display sheet/flexible membrane across the skylight opening 101 where the locking loops 117 on the canister display sheet 115 are be placed over the locking hooks 118 on the end bracket 103 to form a snug fit within the skylight opening 101 defined space.

The openings 119 are placed in the ends of the paired end mounting pieces 111-114 for receipt of the spring tensioned cannisters accepting the projections 112 from each end of the spring tensioned cannisters 110 holding one 111, two 112, three 113, or four 114 of the predesigned and decorated canister display sheets 115 on the individual spring tensioned cannisters 110 that are the choices of the viewer.

The design allows for placement of more than one passthrough cover for a skylight assembly 100 in the designated skylight opening 111 space, adding a layered display and a more multidimensional effect of cannister display sheets of variable transparency in the one skylight opening 101 space, if so desired.

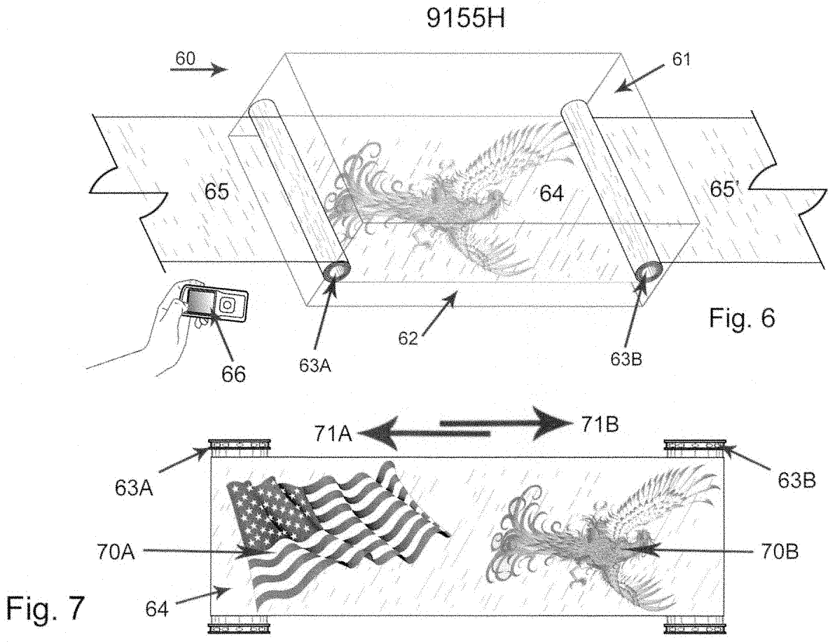

FIG. 6 pictorially depicts the operation of the preferred embodiment of the invention.

Skylight 60 extends through roof 65 from an interior 62 of the building to an exterior opening of the building portion 61. Typically, a waterproof covering is placed over exterior opening 61.

Motorized rollers 63A and 63B have a flexible membrane 64 extending therebetween. Motorized rollers 63A and 63B, in this embodiment of the invention, are controlled by remote control 66 which causes the motorized rollers 63A and 63B to work in unison. That is, only one roller is activated at a time while the other roller is permitted to “free roll”. When neither of the rollers are activated, a brake (not shown) is used to keep the rollers in their chosen positions allowing the image on flexible membrane 64 to be fixed.

FIG. 7 illustrates a flexible membrane having more than one graphical image.

Flexible membrane 64 extends between motorized rollers 63A and 63B and travel between the motorized rollers 63A and 63B as indicated by arrows 71A and 71B.

Images 70A and 70B are imprinted onto flexible membrane 64 allowing the operator to choose which image is to be displayed. In some embodiments of the invention, the flexible membrane contains a panel which is totally opaque, allowing the skylight to be selectively “closed” of ambient light. This embodiment is ideal for a bedroom where the user wants darkness to sleep.

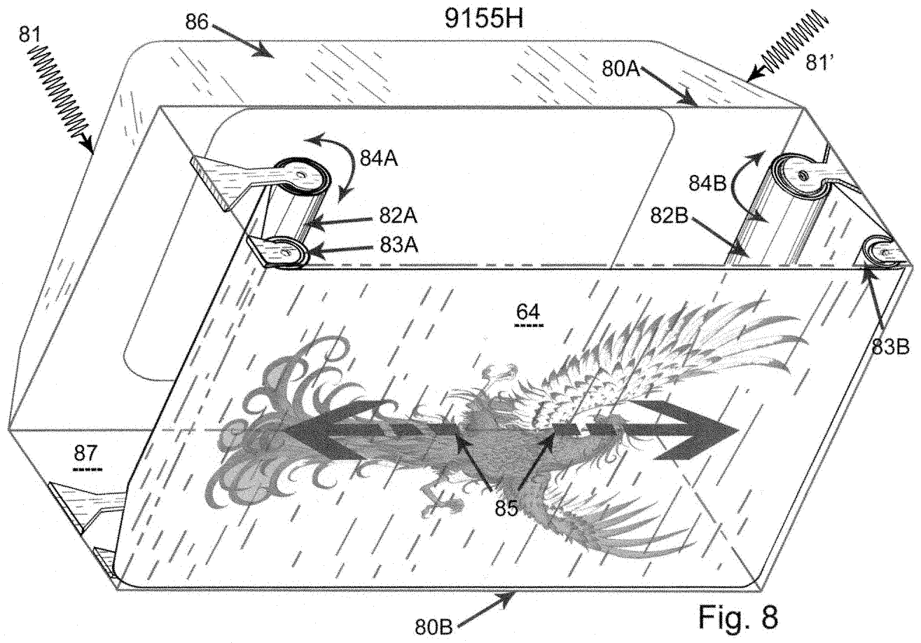

FIG. 8 graphically illustrates an alternative embodiment of the invention.

Skylight 87 has an exterior opening 80A which is sealed from the elements using transparent covering 86. This allows sunlight 81 to penetrate and pass through skylight 87 to illuminate the interior of the building via bottom opening 80B.

Flexible membrane 64 is rolled on motorized rollers 82A and 82B. Flexible membrane 64 passes from one motorized roller (84A, 84B) to the other via small rollers 83A and 83B which keep flexible membrane close to the walls of skylight 87.

This embodiment of the invention provides for an image which extends substantially across the entirety of the width of skylight 87.

It is clear from the forgoing that the present invention creates an enhanced skylight.

What is claimed is:

1. A skylight assembly comprising:
a) a skylight having a tubular member having,
1) a first opening above a roof line, said first opening being sealed on an exterior portion by a light permeable member, and,
2) an opposing second end of said tubular member being unsealed and communicating with an interior of a room; and,
b) a flexible membrane adapted to be selectively positioned across the tubular member proximate to the second end, said flexible membrane being translucent and having a graphical image imprinted thereon.

2. The skylight assembly according to claim 1, wherein said flexible membrane, when not in use, is secured around a first roller positioned within the tubular member.

3. The skylight assembly according to claim 1, further including a first motor adapted to selectively move the flexible member.

4. The skylight assembly according to claim 3, wherein said first motor is remotely activated.

5. The skylight assembly according to claim 4,
a) further including a spring mechanism adapted to pull the flexible membrane onto the first roller; and,
b) wherein the first motor is position on a side of the tubular member opposing the first roller and adapted to pull the flexible membrane from the first roller.

6. The skylight assembly according to claim 4, further including a second roller operable by the first motor such that said flexible membrane is rolled onto the second roller during withdrawal from the first roller.

7. The skylight assembly according to claim 6, further including a second motor adapted to selectively operate the first roller.

8. The skylight assembly according to claim 7, wherein the flexible membrane contains at least two graphical images thereon.

9. The skylight assembly according to claim 7, further including a brake mechanism to secure the first and second motor when the first and second motor are not activated.

10. The skylight assembly according to claim 9, further including a control mechanism adapted to prevent the first motor and the second motor from being activated simultaneously.

11. A skylight assembly comprising:
a) a tubular member communicating between an exterior of a building and an interior of the building;
b) a weather proof light permeable member protecting the tubular member from exterior elements; and,
c) a flexible membrane adapted to selectively extend from a first side of the tubular member to an opposing second side of the tubular member, said flexible membrane having a graphical image imprinted thereon.

12. The skylight assembly according to claim 11, further including:
a) a first roller positioned within the tubular member, said first roller holding said flexible membrane; and,
b) a first motor adapted to selectively move the flexible membrane from the first roller.

13. The skylight assembly according to claim 12, further including a spring mechanism adapted to pull the flexible membrane onto the first roller.

14. The skylight assembly according to claim 12, further including a second roller operable by the first motor such that a portion of said flexible membrane is rolled onto the second roller during movement from the second roller by the first motor.

15. A skylight assembly comprising:
a) a skylight having a generally rectangular tubular member establishing a first opening past a roof level and an opposing second opening of said tubular member communicating with an interior of a room; and,
b) a flexible membrane adapted to selectively extend across the tubular member between the first opening and the second opening, said flexible membrane having a graphical image imprinted thereon.

16. The skylight assembly according to claim 15, further including a first motorized roller and a second motorized roller, said flexible membrane extending between the first motorized roller and the second motorized roller.

17. The skylight assembly according to claim 16,
a) further including a first and a second free rollers; and,
b) wherein the flexible passes from the first motorized roller to the second motorized roller via the first and second free rollers.

18. The skylight assembly according to claim 16, further including a brake mechanism to secure the first motorized roller and second motorized roller when said first motorized roller and the second motorized rolls are not activated.

19. The skylight assembly according to claim 18, further including a control mechanism adapted to prevent the first motorized roller and the second motorized roller from being activated simultaneously.
